(19) United States
(12) Patent Application Publication
(10) Pub. No.: US 2022/0015306 A1
(43) Pub. Date: Jan. 20, 2022

(54) SYSTEM THAT PROVIDES SHADE FOR AGRICULTURAL ENVIRONMENTS

(71) Applicant: STRATEGIC SOLAR ENERGY, LLC, Chandler, AZ (US)

(72) Inventor: Thomas Headley, Scottsdale, AZ (US)

(73) Assignee: STRATEGIC SOLAR ENERGY, LLC, Chandler, AZ (US)

(21) Appl. No.: 17/379,776

(22) Filed: Jul. 19, 2021

Related U.S. Application Data
(60) Provisional application No. 63/053,292, filed on Jul. 17, 2020.
(60) Provisional application No. 63/053,249, filed on Jul. 17, 2020.

(51) Int. Cl. A01G 13/02; H02S 20/10

(52) U.S. Cl. CPC A01G 13/0206; H02S 20/10

(57) ABSTRACT

Systems that provide shade for agricultural environments are disclosed, including a shade system. The shade system provides a predicted amount of shade and sunshine to an area covered by the shade system. The shade system includes a plurality of elevated rectilinear shade structures, wherein each shade structure of the plurality of elevated rectilinear shade structures has a long side and a short side, the shade structures grouped together, oriented and aligned such that each shade structure of the plurality of elevated rectilinear shade structures has long sides generally oriented north to south and each shade structure of the plurality of elevated rectilinear shade structures has short sides generally oriented east to west.

### CROSS-REFERENCE TO RELATED APPLICATIONS

This application is a non-provisional of, and claims priority to, Provisional Application Ser. No. 63/053,292 filed Jul. 17, 2020 and entitled “SYSTEM THAT INCREASES SOLAR ENERGY PRODUCTION FOR LARGE SCALE SOLAR ENERGY INSTALLATIONS”, and is a non-provisional of, and claims priority to, Provisional Application Ser. No. 63/053,249 filed Jul. 17, 2020 and entitled “SYSTEM THAT PROVIDES SHADE FOR AGRICULTURAL ENVIRONMENTS”, all of which are hereby incorporated by reference in their entirety.

### TECHNICAL FIELD

The present disclosure relates to shade structures.

### BACKGROUND

Many areas may receive more sunlight than needed for whatever purpose the owner of such land may wish to use the land. For example, many areas may receive more sunlight than needed to grow or raise agricultural products that the owner of such land may wish to grow or raise. Accordingly, it may be useful to erect structures on the land that provide shade. The shade structure may be designed to allow a determined amount of sunlight, on average, to reach the ground.

### SUMMARY

In an example embodiment, a shade system that provides a predicted amount of shade and sunshine to an area covered by the shade system, comprises: a plurality of elevated rectilinear shade structures, wherein each shade structure of the plurality of elevated rectilinear shade structures has a long side and a short side, the shade structures grouped together, oriented and aligned such that each shade structure of the plurality of elevated rectilinear shade structures has long sides generally oriented north to south and each shade structure of the plurality of elevated rectilinear shade structures has short sides generally oriented east to west.

In an example embodiment, a method of providing a known amount of shade and sunshine to land or water, comprises: determining a desired height and a desired width of a plurality of shade canopies; determining a desired length of the plurality of shade canopies, such that a length is greater than a width of the plurality of shade canopies; determining a desired separation between each shade canopy; constructing more than one structure over the land or water, each structure holding one or more of the plurality of shade canopies of desired dimensions and each structure separated from its neighbor by the desired separation; and constructing the more than one structure so that long sides of the plurality of shade canopies are oriented north to south and the short side of the plurality of shade canopies are oriented east to west, wherein one or more of the plurality of shade canopies include one or more solar panels.

In an example embodiment, a microgrid energy system comprises: at least one of solar panels, an energy storage system, a generator and a control system, wherein a solar energy portion of the microgrid energy system comprises a group of elevated structures covering land or water where plants or animals are raised, each supporting one or more solar energy shade canopies, the longer side of each solar shade canopy being oriented from north to south and the shorter side of each solar shade canopy being oriented from east to west, wherein each solar shade canopy has a height dimension, a width dimension and a distance of separation dimension from the solar shade canopy's neighboring canopy to the east or west, and those dimensions are predetermined to work together to provide a desired location and desired ratio of sunshine and shade to an area covered by the microgrid energy system.

In an example embodiment, a shade system that provides a predicted amount of shade and sunshine to an area covered by the shade system, comprises: a plurality of elevated rectilinear shade structures, wherein each shade structure of the plurality of elevated rectilinear shade structures is a “solar table”, including a first solar table, wherein each shade structure has a long side and a short side, wherein the shade structures are grouped together but do not touch, oriented and aligned such that each shade structure of the plurality of elevated rectilinear shade structures has long sides generally oriented north to south and each shade structure of the plurality of elevated rectilinear shade structures has short sides generally oriented east to west.

### BRIEF DESCRIPTION OF THE DRAWINGS

With reference to the following description and accompanying drawings:

FIG. 1 illustrates a perspective view of an example embodiment of the system;

FIG. 2 illustrates an example embodiment of the systems and methods described herein;

FIGS. 3a-3g illustrate shade and sunshine locations with the sun at various azimuths for the version of the system illustrated in FIG. 2;

FIG. 4 illustrates a top view of an example embodiment of the systems and methods described herein;

FIG. 5 illustrates examples of configurations of the structures in example systems;

FIG. 6 illustrates examples of solar panel mounting options;

FIG. 7 illustrates an example microgrid configuration;

FIG. 8 illustrates the impact of changing canopy heights on shade and sunshine patterns;

FIG. 9 illustrates the impact of changing the ratio of canopy width to canopy separation on shade and sunshine patterns;

FIG. 10 illustrates examples of options for additional uses of the structure; and

FIG. 11A-11C illustrate example solar table structures.

### DETAILED DESCRIPTION

An embodiment may be a system for shading agricultural areas. The system may be designed to provide a predetermined mix of shade and sunshine to the area that is covered by the system. Such an area may include areas of land and areas of water. A mix of an amount of shade and an amount of sunshine for a particular site may be selected to improve growing conditions for a particular type of plant or types of plants under the shade system. As used herein, “under” may include any area shaded by the system at some time of some day of the year. In an example embodiment, the mix of the amount of shade and the amount of sunshine may also be selected to improve the living conditions for a particular type of animal or types of animals living under the system.

The system may comprise multiple elevated shade canopies. The elevated shade canopies may be long and narrow and may be positioned with the long direction pointed generally north and south. For example, in an embodiment, the long sides of each structure may be oriented within ±30° of a directly north to south orientation. Other orientations are also possible, however. By knowing the latitude where the shade system is located and by specifying the height and width of the individual shade canopies that comprise the system, and by specifying the distance between each canopy, the system may be tuned to provide chosen quantities of shade and sunshine in specific locations to enhance the growth of the specific plants, to provide better conditions for the animals, or a combination of both to provide chosen quantities of shade and sunshine in specific locations to enhance the growth of the specific plants and to provide better conditions for the animals. The system may be configured as the solar energy generation system and may be configured as the renewable energy source portion of a microgrid system which provides energy for local consumption or to the utility.

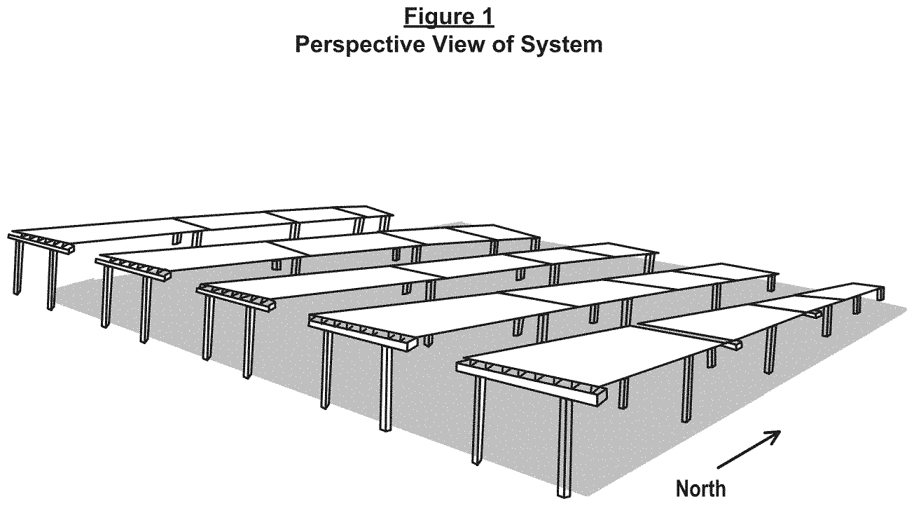

In an example embodiment, a system may include multiple specifically dimensioned, located and positioned shade structures. Each structure may be configured to have one or more shade canopies. The multiple structures with shade canopies that comprise the system may be generally oriented with the long dimension of the structures going north and south and the narrow dimension of the structures going east and west (see FIG. 1). The north to south length of the shade canopies may be whatever the land or water area allows, for example, the shade canopies could reach from property line to property line, or may be whatever the system designer chooses, for example, covering only a portion of the area available from north to south. The number of canopies and land used for the canopies from east to west can be all or only a portion of the area available from east to west. Given the latitude of the system's location, at all times of day and for each day of the year, as the azimuth and elevation of the sun changes from sunrise to sunset, the height, width and separation of the shade canopies determine the location and duration of shade and sunshine reaching the area under the system.

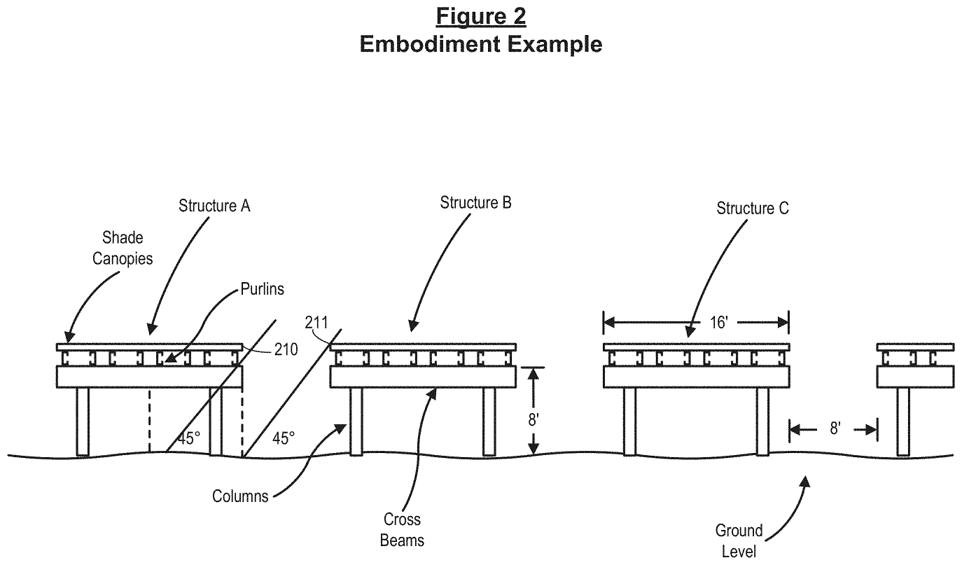

One embodiment of the structures that comprise the shade system is illustrated in FIG. 2. In this example, the width of the shade canopy is 16 feet and the east to west separation between adjacent solar canopies is 8 feet. This combination determines that the shade to sunshine ratio under the system will be 2 to 1. Other shade canopy widths and shade canopy separations are possible. Some combinations of shade canopy widths and shade canopy separations result in the same shade to sunshine ratio and some combinations of shade canopy widths and shade canopy separations may result in different shade to sunshine ratios. Further, for this example, the height of the shade canopy is 8 feet. Moreover, the height of the shade canopy is measured from the ground directly below an edge of the canopy to the top of the shade panel (see, e.g., 210 and 211). In this manner, the edges of the shade under the shade structure are associated with the respective top most edges of the shade panels on the shade structure. In this example embodiment, the height to distance of separation between canopies ratio is 1:1.

This combination of the specifications for the group of structures in the system causes sunshine in the Northern Hemisphere to 1) hit only the area under the entire easternmost half of each structure when the azimuth of the sun is 135° (southeast), 2) hit only the area between adjacent structures when the azimuth of the sun is 180° (directly south) and 3) hit only the area under the entire westernmost half of each structure when the azimuth of the sun is 225° (southwest) and for all other areas of the ground to be in shade. At other times, the shade and sunshine will occupy other areas as the azimuth and elevation of the sun changes throughout the day.

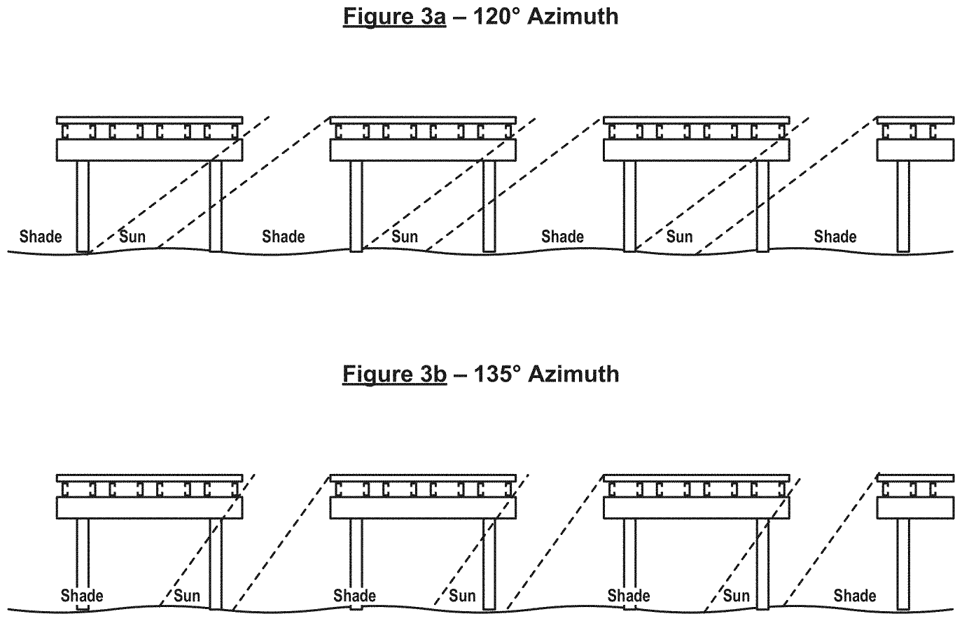

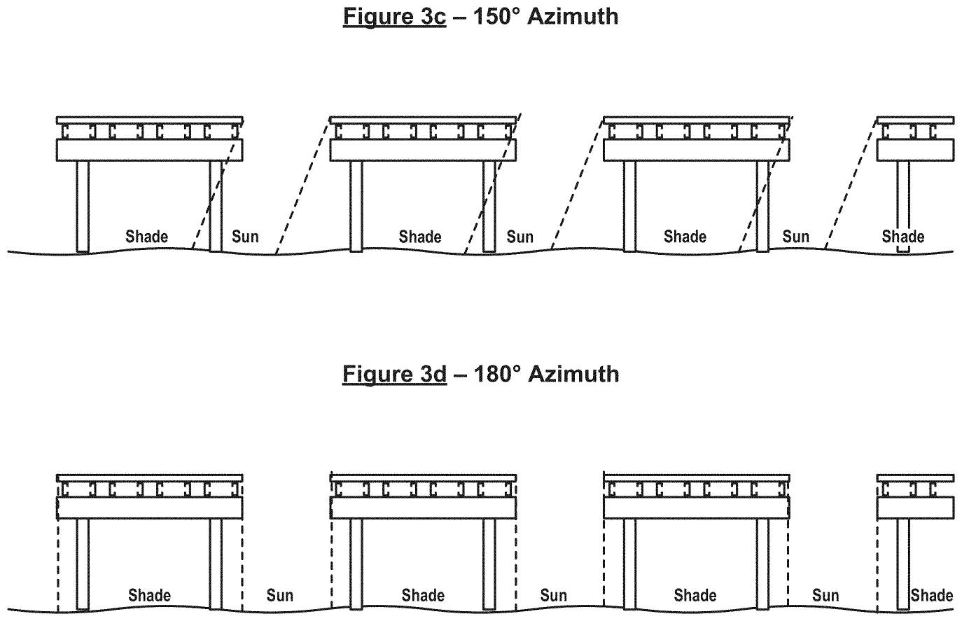

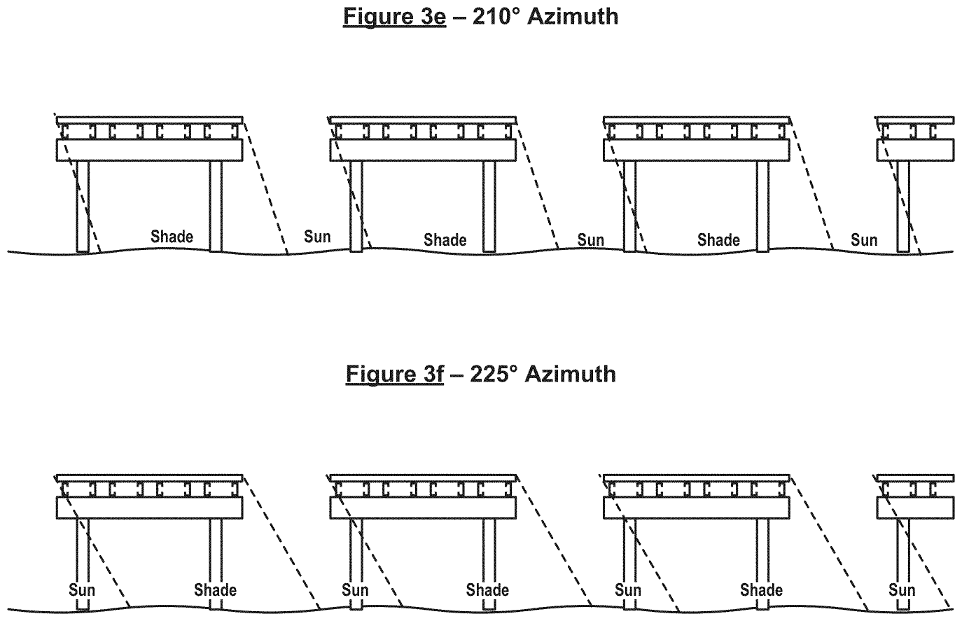

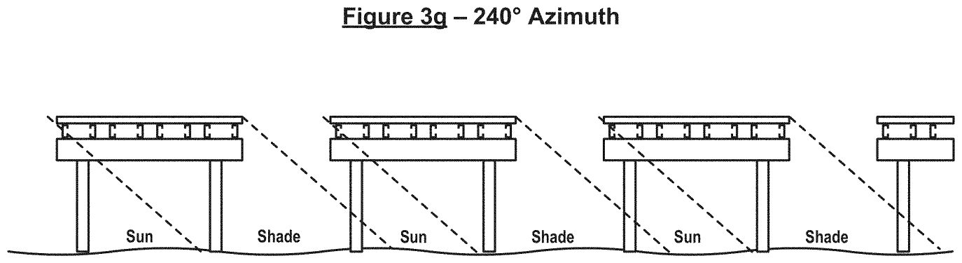

FIGS. 3a through 3g illustrate the shade and sunshine patterns on the ground caused by the system comprised of the example structures in FIG. 2 as the azimuth of the sun changes during the day in the Northern Hemisphere. It should be noted that all other combinations, where the shade canopy is twice as wide as the separation distance between adjacent canopies and the shade canopy height is equal to one-half the shade canopy width (for instance, 6 feet high and 12 feet wide solar canopies separated from each other by 6 feet, or 15 feet high and 30 feet wide solar canopies separated from each other by 15 feet) result in the same shade and sunshine pattern on the ground as the combination of dimensions illustrated in FIG. 2. In an example embodiment, the shade canopy system is designed by varying the height and width of the shade canopy and distance of separation between adjacent canopies to adapt to different heights of plants grown underneath (e.g., lemon trees are taller than grass), the species of animals to be raised underneath (e.g., cattle are taller than turkeys), any vehicles to be moved thereunder, and any buildings and equipment to be covered (e.g., the height of the shade canopies can be dictated by any buildings and equipment to be covered) and still get the desired shade and sunshine pattern.

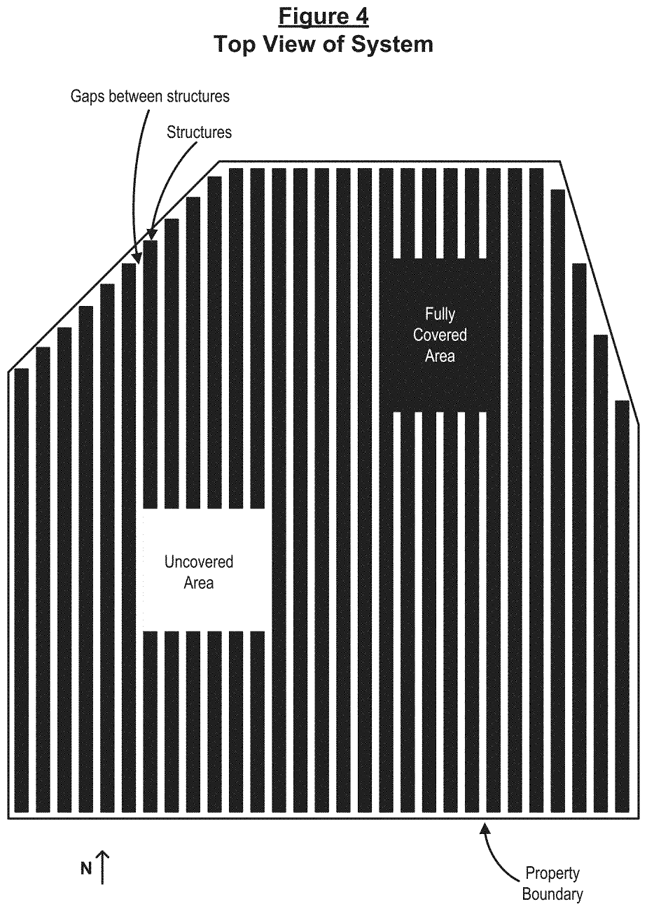

FIG. 4 illustrates the top view of an example system in an exemplary system application. The view illustrates how the system may be adapted to different areas and fence lines, have open areas where objects may be located that should not be covered, and have fully shaded areas where fully shaded areas are desired. If so desired, more than one combination of system height, shade canopy width and row-to-row spacing may be dimensioned and may be included in a single system. Such variations within a project may, for example, be selected to design for different plants and/or animals under different portions of the system.

Other combinations of shade and sunshine than the ones illustrated in FIGS. 3a through 3g may be desirable. For instance, as you move north or south from the equator and depending on the types of vegetation and animal life to be supported under the structure, you may want different shade and sunshine patterns. Also, cloudier locations, such as parts of Ireland, as one example, may prefer a design with a ratio of shade and sunshine that is biased toward less shade while sunnier locations such as the Southwest of the United States, as one example, may prefer the opposite.

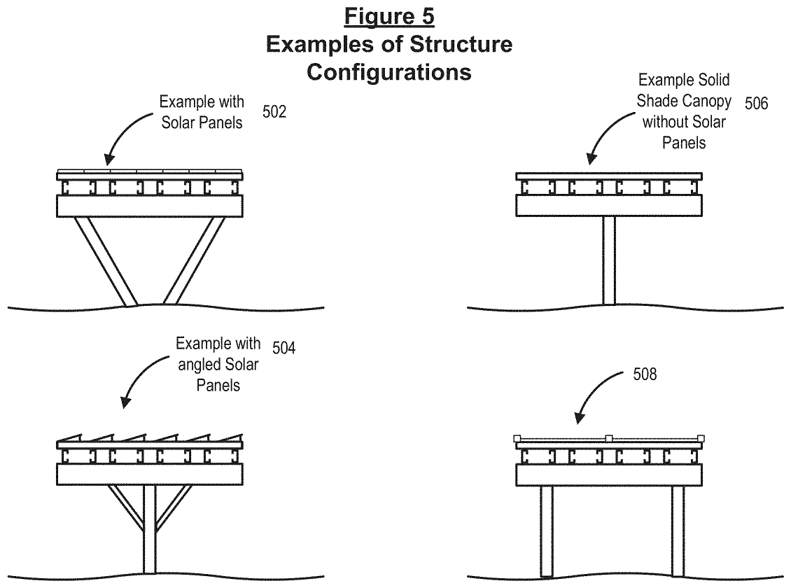

In accordance with various example embodiments, the support structure of the solar canopies of the shade system may be designed and constructed in any suitable way. Several examples are illustrated in FIG. 5, shown from the end-view, looking north to south, but many others may be feasible and may be included in some embodiments. Which type of structure is best suited for a particular system in a particular location may be decided after considering factors, such as cost, local design parameters, soil type, required height, as well as other factors that may impact structure design. For example, the shade structure may have a “V” shape design, with angled center vertical supports. In another example embodiment, the vertical supports may be two columns located at the edges, or near the edges of the shade canopy.

The structures that support the elevated shade canopies and comprise the system may be constructed of various metals, concrete, wood or any other structural material or combinations of structural materials and may have a variety of configurations, some examples of which are shown in FIG. 5. The examples of FIG. 5 include an example with solar panels 502, an example with angled solar panels 504, an example with a solid shade canopy 506, and an example with shade cloth 508. While these examples are illustrated on specific support structures, it will be understood that each of the examples may be applied to any of the example support structures or other support structures that will be apparent to those of skill in the art after reviewing the specification and drawings.

Typically, the vertical supports illustrated in FIG. 5 may be configured to support a horizontal, or nearly horizontal, structure that supports the shade creating objects, such as the examples 502, 504, 506, 508. Nearly horizontal may mean anything less than 15 degrees in angle. The horizontal structure may comprise beams, purlins, cables, rods and any suitable structure for holding a shade creating object in a fixed location.

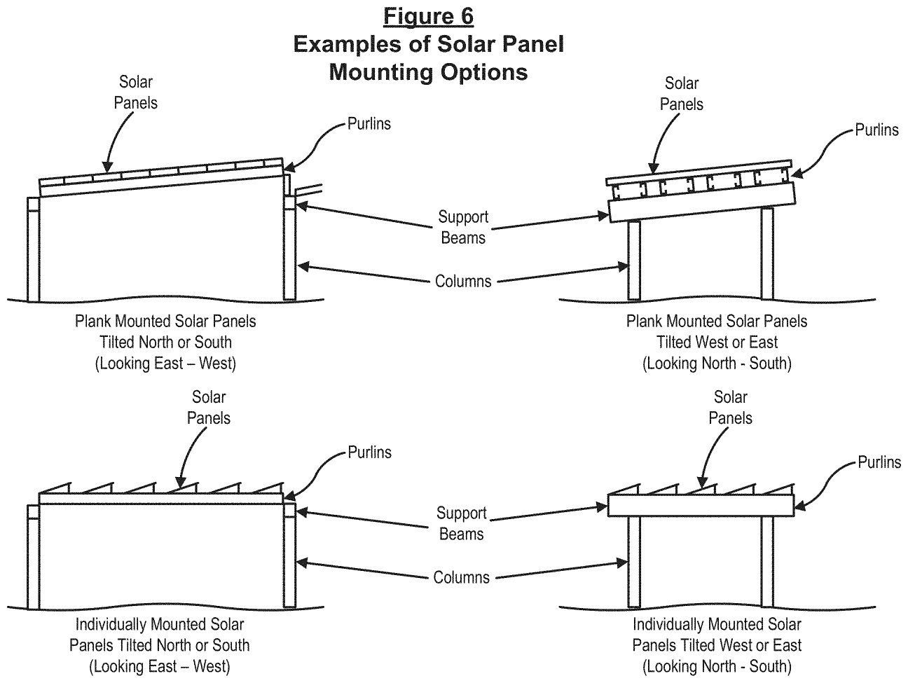

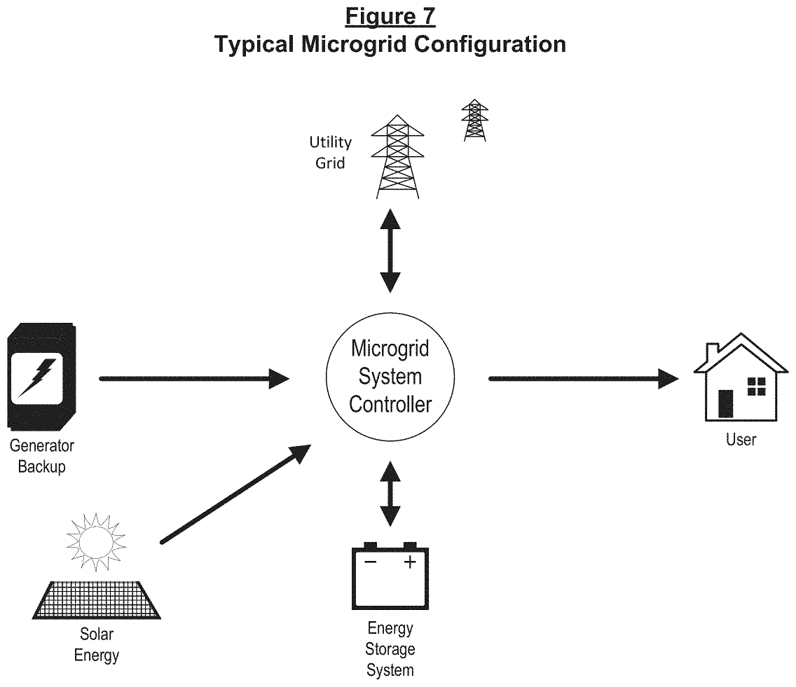

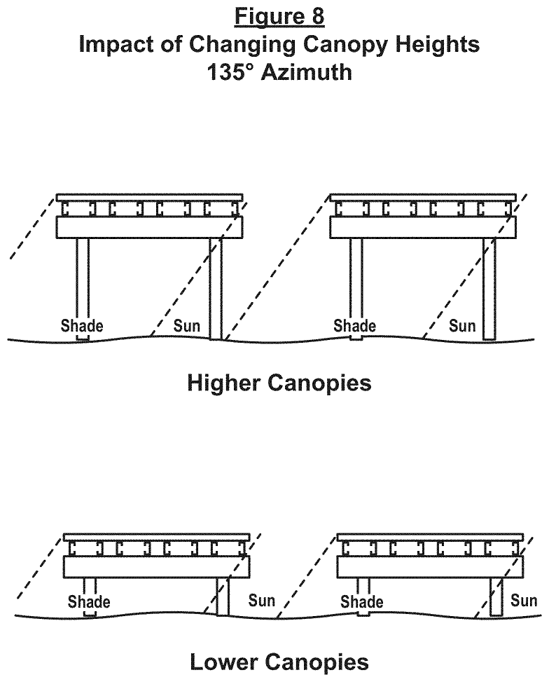

The system's shade canopies can be made of metal, fabric, plastic or many other materials. The shade canopies can be opaque or have varying degrees of translucence. Some of the canopies on the structures that make up the system can be clear or even nonexistent, i.e., the shade system may purposefully leave out shade canopies in some areas where a shade canopy could have been installed. In an embodiment, some of the shade canopies may be comprised of solar panels or other solar energy collection means. When the shade canopy is comprised of solar panels, the solar panels may be mounted individually or ganged to form planks of solar panels. The solar panels may be tilted at any angle, but preferably in the range of 0° to 15° from horizontal in some example embodiments. Further, the solar panels may be tilted to the north, south, east or west or any direction in-between. See FIG. 6.

In the Northern Hemisphere, tilting the panels to the south typically maximizes the total daily output of the system, whereas tilting the solar panels to the north reduces the energy output. The opposite is true in the Southern Hemisphere. In the Southern Hemisphere, tilting the panels to the south reduces the total daily output of the system, whereas tilting the solar panels to the north typically maximizes the energy output. In both hemispheres, tilting the solar panels to the east will increase morning energy output but reduce afternoon energy output. Tilting the solar panels to the west will reduce morning energy output but increase afternoon energy output.

An embodiment may leave out one or more shade structure elements, such as solar panels. For example, solar panels may be purposely left out of the solar canopy or spaced closer together or further apart, be monofacial or bifacial and be of different degrees of transparent to opaque to allow different amounts of energy to be collected and different patterns of sunshine to reach the area covered, if so desired. In some embodiments, other arrangements of the solar panels in canopies of the system and other solar energy collection materials, such as shingles, cloth and paint among others, mounted on any appropriate surface are also contemplated.

As discussed above, generally, solar panels may be mounted on the shade canopies. In some embodiments, the solar panels may be mounted such that they are angled toward the sun. For example, in the Northern Hemisphere, the solar panels may be angled towards the south. In other words, the north end of the solar panel may be higher than the south end of the solar panel. The opposite may be true in the Southern Hemisphere. For example, in the Southern Hemisphere, the solar panels may be angled towards the north. In other words, the south end of the solar panel may be higher than the north end of the solar panel. Other orientations for the solar panels are also possible, including solar panels oriented east to maximize sun received first thing in the morning, oriented west to maximize sun received before sunset. In some embodiments, solar panels may lay flat, e.g., level. In other embodiments, the solar panels may be angled, e.g., towards the sun, aligned with an underlying structure, or otherwise positioned.

In an example embodiment, the solar panels are not solar tracking panels. Stated another way, the solar panels are set in a fixed orientation and are not movable unless detached from the structure. Stated another way, the solar panels are not configured to track the sun or to change their orientation during operation. Solar tracking panels have spacing requirements that are counter-productive to producing shade. In particular, solar-tracking panels require significant spacing between rows of panels to avoid self-shading.

Height and width of the solar canopy and distance of separation to adjacent canopies also gives the system designer changeable parameters that may be used to optimize the energy production and to optimize the cost of the system.

As discussed above, in various example embodiments, the solar panels are directed towards the sun or may lay flat. In an example embodiment, the angled solar panels are set at an angle selected to maximize or optimize the energy produced per individual solar panel over a particular period of time.

Stated another way, in an example embodiment, a first solar structure comprises a solar-shade structure with panels in a fixed orientation that are flat, or that are angled relative to horizontal significantly less than the angle of a second solar structure. In that example embodiment, if both the first solar structure and the second solar structure were built to reside within the same boundaries, such that the outer boundary of the two structures were the same, then (1) the average energy generation (energy density) for the area is greater for the first solar structure than the second solar structure, and (2) the panel density for the area is greater for the first solar structure than for the second solar structure. Therefore, in an example embodiment, although the individual solar panels are designed to operate at less than their optimal operation orientation, they collectively are designed to generate more energy than if they were oriented at their optimal operation orientation.

Flat solar panels may produce more energy per unit area of land because the flat solar panels do not shade solar panels near them. The solar panels may be butted up against each other to maximize the number of solar panels in a given area, and thereby maximize the energy produced in that area. Alternatively, the solar panels may still be spaced apart to provide sunlight to areas generally below and in the vicinity of the solar panels, while still maximizing the energy produced for the amount of solar energy available for a given area. In other words, the solar energy produced may be maximized within the constraints of solar energy needed to grow crops, the solar energy for livestock, or the solar energy for any other use in addition to the use of solar energy for the solar panels. Angled solar panels may shade other solar panels if the rows of solar panels are too close together. Accordingly, flat solar panels may produce less energy per panel, but may produce more energy per unit area.

Angled solar panels may produce more energy per individual solar panel because solar panels are more efficient per unit area of the solar panel when pointed directly at the sun as compared to the flat solar panel. However, using angled solar panels may reduce the number of solar panels in a given area because rows of solar panels may have to be separated to avoid one row of solar panels from shading another row of solar panels. The reduction in the number of solar panels because of the use of angled solar panels may decrease total energy production more than the increase in energy production per solar panel of all the solar panels combined. Accordingly, angling the solar panels may, in some examples, reduce overall energy output of a system as compared to flat panels. Additionally, in some examples, the greater the angle of tilt of the solar panel, the lower the number of solar panels can be installed in a defined area and the less consistent the shade produced by those solar panels (and the corresponding structure) may be.

Angling solar panels toward the sun may be most important when the solar panels are relatively expensive compared to the land on which the solar panels are placed, because angling the solar panels toward the sun may maximize energy production per solar panel and thus, such an orientation may decrease costs by lowering the number of solar panels used. Conversely, mounting the solar panels flat may be most important when the solar panels are inexpensive compared to the land on which the solar panels are placed, when maximizing the amount of energy produced per unit area of land is an important design goal, and/or when other intangibles, such as generating shade, are also important considerations.

Angling the solar panels may also be used when the amount of energy needed by a particular project is less than the amount of energy that may be produced using flat solar panels in a given area. For example, in a project where energy is needed to pump water from a well, an angled solar panel that produces the needed energy to pump the water may be all that is needed. In such a project, maximizing the total energy may not be necessary (unless the land available is very small compared to the amount of energy that needs to be produced on that land or the amount of water to be pumped is very large compared to the amount of land available for solar panels).

Some projects may include a mix of angled solar panels and flat solar panels. For example, an open area of the project may include flat solar panels to maximize energy collection per unit area under the panels. An area at the western edge of the project having trees along the edge may be angled to the east to capture morning sun because panels in this area may be shaded in the late afternoon and evening. Conversely, an area at the eastern edge of the project having trees along the edge may be angled to the west to capture late afternoon and evening sun because panels in this area may be shaded in the early morning. In other examples, it may make sense to angle panels to the north if trees lie along the southern edge of the property. In another example, it may make sense to angle panels to the south if trees lie along the northern edge of the property. Accordingly, it will be understood that various geographic features may need to be considered when designing such a project. Thus, in an example embodiment, the panels on an interior portion of the overall system may be flat, where the panels on the exterior portions of the system may be angled inwardly.

In some embodiments, it may make sense to maximize solar energy production at particular times. For example, energy consumption on an energy grid may increase as people return home in the evening. Thus, it may make sense to angle solar panels to collect solar energy for increased electricity production in the evening. Accordingly, solar panels might be angled to the west in some projects.

In some embodiments, “maximizing” the amount of energy per solar panel or “maximizing” the energy for the given area of the project may still be done in the context of providing a certain percentage of sunlight to the ground below the solar panels, the shade structure, or both. Accordingly, the discussion of “maximizing” energy may be applied to the other concepts discussed herein. For example, a project designed to provide 50% solar energy to plants or animals below it may still use flat solar panels to maximize the amount of solar energy that is produced by the area available for energy production.

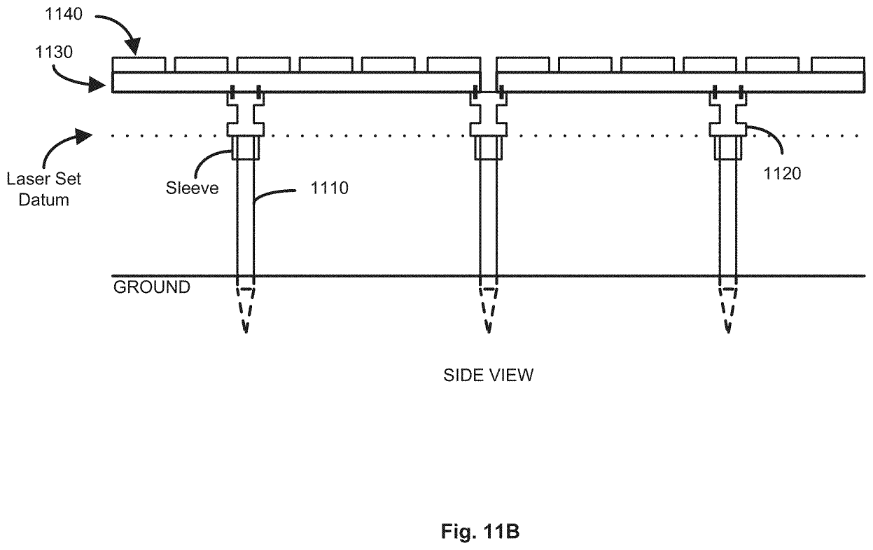

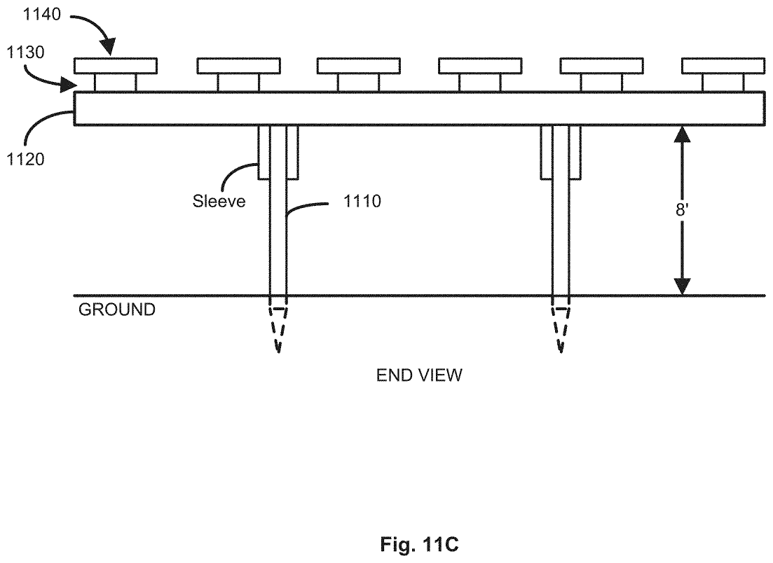

With momentary reference now to FIGS. 11A, 11B, and 11C, in accordance with another example embodiment, a solar table 1100 may comprise three sets of two column pairs. Each column 1110, in an example embodiment is a drilled column (i.e., screw type securement), though the columns could be secured in the ground using concrete or other methods of attachment. A crossbeam 1120 may extend between a pair of columns 1110. As illustrated in FIG. 11A, three crossbeams (1120 typ.) are supported by two columns (1110 typ.) each. In this example embodiment the columns 1110 may be separated by about 25 feet between each pair, and the pairs of columns may be separated by about 20 feet, however other separation distances may be used. With reference to FIG. 11B, the structure 1100 may be configured to support purlins 1130 which in turn support the solar panels 1140. Each purlin 1130 may be supported by at least two of the crossbeams. Moreover, in an example embodiment, each solar panel 1140 may be supported by at least two purlins 1130. In an example embodiment, the structure is designed to hold the solar panels from about 4 feet to about 20 feet above the ground over hills and washes and other ground irregularities. In this example embodiment, the solar table 1100 comprises a panel matrix that is six panels by twelve panels, though any suitable number of panels may be used.

Solar tables similar to the ones described above placed end-to-end may make up the long, narrow solar structure described above. The long, narrow solar structures may be placed side-to-side in rows spaced apart to complete the solar structure and provide large amounts of energy. However, the solar tables can also be used as a standalone structure or in small groups for installations that require less solar energy. In an example embodiment, a ‘long’ structure may be 2, 3, 4, 5, 10 times as long as the ‘narrow’ width, though other ratios may be suitable as well.

In an example embodiment, a solar energy system comprises: a plurality of elevated rectilinear solar energy structures covering an area, wherein at least two of the solar energy structures of the plurality of elevated rectilinear solar energy structures each comprise a solar table, wherein each solar table comprises a first pair of columns supporting a first crossbeam, a second pair of columns supporting a second crossbeam, and a third pair of columns supporting a third crossbeam, wherein each column is secured to the ground with a screw type securement, and each solar table further comprising pairs of purlins supported by the first, second, and third crossbeams, and each solar table further comprising solar panels, with each solar panel supported by at least one pair of purlins in a fixed manner forming a solar energy collection canopy, wherein each solar table comprises a long side and a short side, the plurality of elevated rectilinear solar energy structures grouped together, oriented and aligned such that the long side of each of the solar energy structures are generally parallel.

More broadly, in one example embodiment, a first solar table may be connected to a second solar table. In an example embodiment, a first solar table may comprise a single column and a single crossbeam and a second solar table may comprise a single column and a single crossbeam. In this example embodiment the first solar table is connectable to the second solar table by connecting at least one purlin of one structure at least one purlin of the other structure. The structures can be connected to each other by means of plates which connect the first and second structures purlin to purlin. In an example embodiment, the structures may be connected end-to-end along the direction of the purlins (i.e., in the long direction). In this manner the structures are configured to provide mutual lateral structural support. In an example embodiment, the solar canopy is of sufficient height above the area to allow the area below to be used for something other than collection of solar energy. When the shade canopies are comprised of solar energy collection materials, the system may be incorporated as the solar energy array of a microgrid system. Microgrid systems may deliver energy at all times of the day, seven days a week and fifty-two weeks a year, whether the sun is shining or not. For example, in addition to a solar energy array, microgrids may have one or more of 1) battery storage or other means to store electricity, 2) a generator and 3) a control system that manages the interchanges between the microgrid components and also manages the interaction with the energy user and potentially with a utility grid. A schematic diagram of a typical microgrid system is provided in FIG. 7.

An example system with the long dimension pointing north to south and the narrow dimension oriented in the east to west direction may be set up to provide different shade and sunshine patterns than those illustrated in FIGS. 3a through 3g. This may be accomplished by knowing the latitude where the system will be installed and setting the system's principle determining dimensions, the shade canopy height, the shade canopy width and the distance of separation from neighboring canopies based on the latitude and the desired shade to sunshine ratios. The impact of these elements for the design of the system are described below.

Design Elements that may Determine the Shade and Sunshine Patterns Under the System
1. Latitude of the system: Determines the path the sun will take each day relative to the shade system. For each day of the year, the latitude determines the times for sunrise, solar noon and sunset. For all times of day for each day of the year, latitude determines the azimuth of the sun, the elevation of the sun above the horizon, how quickly the sun gains or loses elevation and how quickly the sun traverses the angles of azimuth.
2. Ratio of the width of the shade canopy to distance separating adjacent canopies: This ratio determines the amount of shade the system provides compared to the amount of sunshine permitted to hit the ground or water under the system. If the widths of the shade canopies are equal the separation distance between canopies (a ratio of 1 to 1), then the area under the system is half shade and half sunshine. If the widths of the shade canopies are twice the separation distance between canopies (a ratio of 2 to 1), then the area under the system is two thirds shade and one third sunshine. By choosing an appropriate ratio between the widths of the shade canopies and the separation distance between canopies, the system designer can specify the desired amount of shade and sunlight to hit the area under the system.
When the system uses solar energy collection apparatus on the shade canopy or as the shade canopy, the ratio of the widths of the shade canopies to the separation distance between canopies also determines the solar energy generation capacity of the system. The higher the ratio of the solar shade canopy widths to the separation distance between canopies, the higher the solar energy generation capacity for the system. Conversely, the larger the gaps versus the widths of the canopies, the more sunshine is allowed to hit the area under the system and is therefore not available to be turned into solar energy.
3. Azimuth of the sun: Determines the directional vector the shade from the north-south oriented structure will cast.
In the morning, when the sun's azimuth is 90° (directly east), the shade from the north-south oriented structure will not be directly under the structure but will be moved directly west as determined by the equation (90°+180°)=270°. When the sun's azimuth is less than 90°, the shade will be moved to the southwest and when the sun's azimuth is greater than 90°, the shade will be moved to the northwest according to the equation above.
At solar noon, the sun's azimuth is either 0° for the Southern Hemisphere or 180° for the Northern Hemisphere. In either case, the shade from the north-south oriented structure will be directed directly back under the structure.
In the afternoon, when the sun's azimuth is 270° (directly west), the shade from the north-south oriented structure will not be directly under the structure but will be moved directly east as determined by the equation (270°−180°)=90°. When the sun's azimuth is less than 270°, the shade will be moved to the northeast and when the sun's azimuth is greater than 270°, the shade will be moved to the southeast according to the equation above.
4. Shade canopy height and the elevation of the sun: Determines the distance the shade will be cast along a directional vector determined by the sun's azimuth.
The distance the shade will travel along the directional vector=(canopy height/tangent (sun elevation angle)). Example: If the canopy is 10 feet high, when the sun's elevation is 60° the shade will travel 10/Tangent (60°)=10/1.732=5.77 feet along the directional vector. This equation is true for any point of the system's shade canopy for the sun's elevation at any particular moment.

### EXAMPLE

Location: Latitude: 30° 16′39″ (Austin, Tex., USA)
Time: Apr. 10, 2020 at 10:10:00 a.m. Central Standard Time
   In the example, the sun's elevation to be 50.2° and azimuth to be 116.1°, which says the shade will be moved in the direction of (116.1°+180°)=296.1° or 26.1° north of directly west.
Shade canopy is 20 feet wide and the space between canopies is 15 feet
   In the example, that 57.1% of the area under the system will be shade (20/(20+15))=0.571 or 57.1% of the area under the system will be shade and 42.9% of the area under the system will be sunshine.
   Further, if the system is set up as a solar energy shade system, the capacity of the system will be 57.1% of potential capacity.
Shade canopy is 10 feet high
   In the example, with the other information above, that the shade will be moved by the amount of (canopy height/tangent (sun elevation angle)) or 10 feet/Tangent) (57.1°)=10/1.546)=6.47 feet in the direction of 296.1° or 26.1° north of directly west.

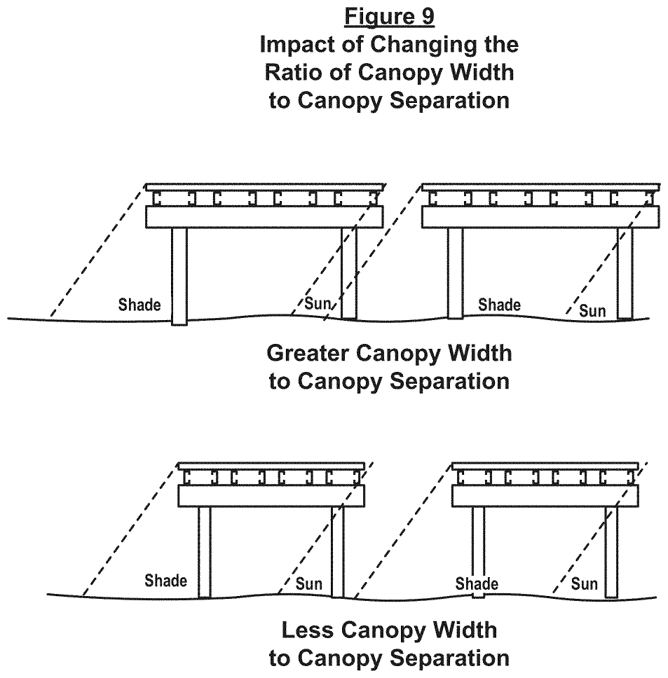

FIGS. 8 and 9 illustrate examples of the impact of changes to the design elements that determine the shade and sunshine patterns under the system. FIG. 8 shows two example structures of the system that have the same shade canopy width and the same separating gap between canopies as FIG. 3b but have different canopy heights. The structures with higher canopies show that the shade and sun have traveled much further than they do in FIG. 3b and the structures with lower canopies show that the shade and sun have traveled less distance than they do in FIG. 3b. FIG. 9 shows the impact of changing the ratio of canopy width to canopy separation. The larger the canopy width to canopy separation ratio, the more shade and less sunshine hits the area under the structure. The smaller the canopy width to canopy separation ratio, the less shade and more sunshine hits the area under the structure. Other changes in the height of the canopies, the width of the canopies and/or in the spaces between canopies of the system may create desirable ratios of shade and sunshine on the area covered by the system.

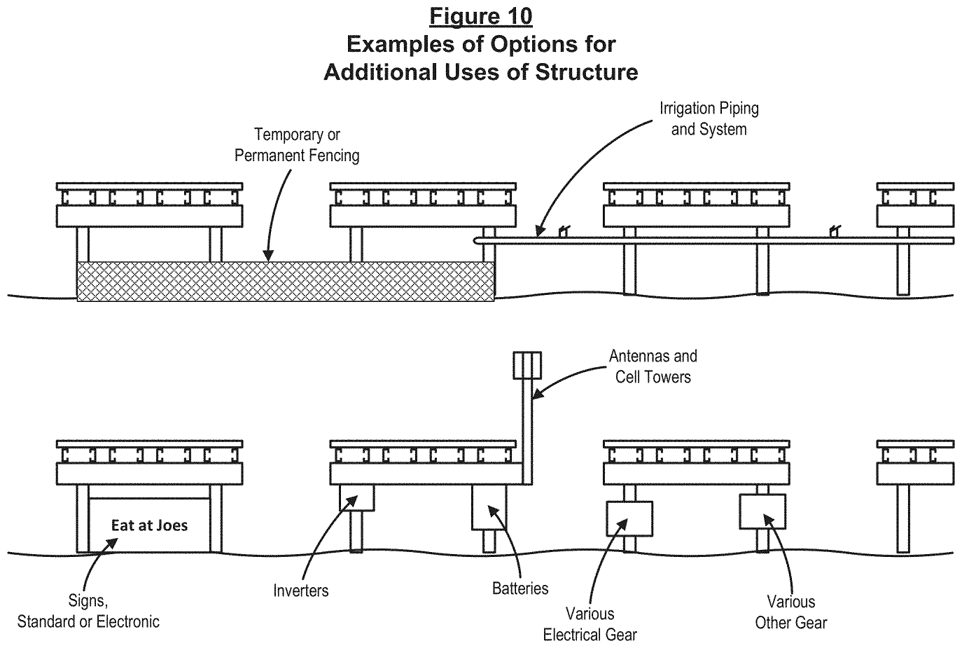

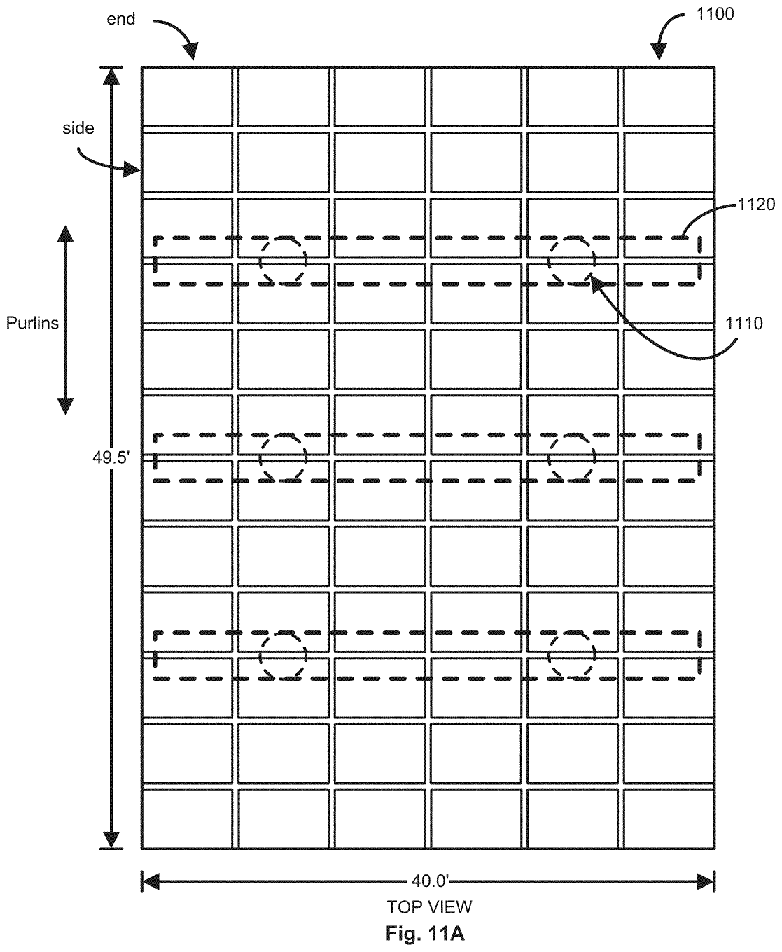

The structures comprising the system may have additional uses beyond their principal use of supporting the shade canopy. The structures may be used to support permanent or temporary fences to control livestock, keep out pests, for security or for other purposes. The structures may be used as supports for water piping for an irrigation system, for providing water to livestock, for pumping fluids to or from aquaponics tanks or for systems with solar panels used as part of the shade structure. In another example, the structures may be used as support for inverters, batteries, combiners, or other electronics associated with managing the solar panels or microgrid, or the structures may be used to support other electrical devices unrelated to energy management, such as cell phone transmitters or receivers, lighting systems, signage control systems or security systems. In an example embodiment, the structures may be used to mount lights for working under the system. In another example embodiment, the system may be used to mount lights to enhance plant growth. In an example embodiment, the structure may be used to support standard or electric signage. In an example embodiment, the structures may be used as a support or be a portion of a temporary or permanent shelter or as agricultural enclosures. The structures may be used to support mechanical equipment of all types. Some embodiments may use the structures to support a combination of one or more of the examples listed. Some examples of potential additional uses of the structures that comprise the shade system are illustrated in FIG. 10, but others are also envisioned and included in other embodiments, as will be apparent to those of skill in the art after reviewing this disclosure.

Additional Statements:

In an example embodiment, the shade structures support regular or electric signs for advertising or way finding. In an example embodiment, the shade structures support fixed or movable fences to control livestock, keep out pests or security. In an example embodiment, the shade structures support electronic equipment which may be related and/or unrelated to the operation of the solar energy (e.g., inverters, batteries, combiners, wiring, microgrid control electronics, cell phone towers, lighting control systems, sign control electronics, security electronics, or other electronic equipment). In an example embodiment, the shade structures support irrigation lines. In an example embodiment, the shade structures support water lines for providing water to animals. In an example embodiment, the shade structures support water lines used to transfer water to or from aquaponics tanks. In an example embodiment, the shade structures support security systems. In an example embodiment, the shade structures support lights (e.g., for working livestock when it is dark). In an example embodiment, the shade structures support grow lights (e.g., to enhance plant growth). In an example embodiment, the shade structures support solar panel washing gear (e.g., water lines and sprinkler heads). In an example embodiment, the shade structures support a water system that both rinses the solar panels and waters the land under the system. In an example embodiment, the shade structures support or may be a portion of a shelter or agricultural enclosures.

In an example embodiment, for at least some portion of a length of a shade structure of the plurality of elevated rectilinear shade structures, a height of a shade canopy, a width of the shade canopy and a separation east to west of adjacent shade structures, the portion of the shade structure's length, the height of the shade canopy, the width of the shade canopy and the separation east to west of adjacent shade structures, are consistent for at least one shade structure and a shade structure's neighboring shade structure. In an example embodiment, the shade structure includes a shading element that is not a solar panel for at least part of the shade structure's length. In an example embodiment, some portions of the shade canopy are purposely left out thereby reducing the amount of shade provided. In an example embodiment, one or more of the plurality of shade canopies include a shading element that is not a solar panel. In an example embodiment, some of the portion of the shade structure is purposely left out thereby reducing the shade provided. In an example embodiment, each of the solar shade canopies has a height dimension, a width dimension and a distance of separation dimension from its neighboring canopies to the east and west and those dimensions consistent for at least some of the solar shade canopies in the microgrid energy system. In an example embodiment, some of the portion of the shade structure is purposely left out thereby reducing the shade provided.

In an example embodiment, a method of increasing or decreasing a distance sunshine reaches in a morning and in an afternoon under shade canopies of a shade system is disclosed. The method comprises: providing the shade canopies, the shade canopies comprising a group of elevated shade structures each supporting one or more shade canopies, the longer side of each shade canopy being oriented from north to south; and changing a height of at least one of the shade canopies. In an example embodiment, one or more of the shade canopies include one or more solar panels. In an example embodiment, one or more of the shade canopies include a shading element that is not a solar panel. In an example embodiment, long sides of each structure are oriented by 30° or less either way from a directly north to south orientation. In an example embodiment, one or more types of plants is grown under the shade system. In an example embodiment, one or more types of animals is raised under the shade system. In an example embodiment, one or more of the one or more shade canopies include a shading element that is not a solar panel.

In an example embodiment, a solar energy system comprises: a plurality of elevated rectilinear solar energy structures covering an area, wherein at least two of the solar energy structures of the plurality of elevated rectilinear solar energy structures each comprise a solar table, wherein each solar table comprises a first pair of columns supporting a first crossbeam, a second pair of columns supporting a second crossbeam, and a third pair of columns supporting a third crossbeam, wherein each column is secured to the ground with a screw type securement, and each solar table further comprising pairs of purlins supported by the first, second, and third crossbeams, and each solar table further comprising solar panels, with each solar panel supported by at least one pair of purlins in a fixed manner forming a solar energy collection canopy, wherein each solar table comprises a long side and a short side, the plurality of elevated rectilinear solar energy structures grouped together, oriented and aligned such that the long side of each of the solar energy structures are generally parallel.

While the principles of this disclosure have been shown in various embodiments, many modifications of structure, arrangements, proportions, the elements, materials and components, used in practice, which are particularly adapted for a specific environment and operating requirements, may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A shade system that provides a predicted amount of shade and sunshine to an area covered by the shade system, comprising:
a plurality of elevated rectilinear shade structures, wherein each shade structure of the plurality of elevated rectilinear shade structures has a long side and a short side, the shade structures grouped together, oriented and aligned such that each shade structure of the plurality of elevated rectilinear shade structures has long sides generally oriented north to south and each shade structure of the plurality of elevated rectilinear shade structures has short sides generally oriented east to west.

2. The system of claim 1, wherein the shade structures are defined by a height of a shade canopy, a width of the shade canopy and a separation east to west of adjacent structures.

3. The system of claim 1, wherein the shade structure includes one or more solar panels for at least part of a length of the shade structure.

4. The system of claim 1, wherein the long sides of the shade structure are oriented within ±30° of the directly north to south orientation.

5. The system of claim 1, wherein (a) one or more types of plants are grown under the system, or (b) one or more types of animals are raised under the system.

6. The system of claim 1, wherein at least one of the plurality of elevated rectilinear shade structures supports at least one of water pipes, grow lights, work lighting, security lighting, fixed fencing, movable fencing, a sign, a portion of a shelter, non-solar renewable energy generators, or electrical equipment related to an operation of a plurality of solar energy panels.

7. A method of providing a known amount of shade and sunshine to land or water, the method comprising:
determining a desired height and a desired width of a plurality of shade canopies;
determining a desired length of the plurality of shade canopies, such that a length is greater than a width of the plurality of shade canopies;
determining a desired separation between each shade canopy;
constructing more than one structure over the land or water, each structure holding one or more of the plurality of shade canopies of desired dimensions and each structure separated from its neighbor by the desired separation; and
constructing the more than one structure so that long sides of the plurality of shade canopies are oriented north to south and the short side of the plurality of shade canopies are oriented east to west, wherein one or more of the plurality of shade canopies include one or more solar panels.

8. The method of claim 7, wherein the long sides of each structure are oriented by 30° or less either way from a directly north to south orientation.

9. The method of claim 7, wherein (a) one or more types of plants is grown under the plurality of shade canopies, or (b) one or more types of animals is raised under the plurality of shade canopies.

10. A microgrid energy system comprising:
at least one of solar panels, an energy storage system, a generator and a control system, wherein a solar energy portion of the microgrid energy system comprises a group of elevated structures covering land or water where plants or animals are raised, each supporting one or more solar energy shade canopies, the longer side of each solar shade canopy being oriented from north to south and the shorter side of each solar shade canopy being oriented from east to west, wherein each solar shade canopy has a height dimension, a width dimension and a distance of separation dimension from the solar shade canopy's neighboring canopy to the east or west, and those dimensions are predetermined to work together to provide a desired location and desired ratio of sunshine and shade to an area covered by the microgrid energy system.

11. The microgrid energy system of claim 10, wherein the at least one of the energy storage system, the generator, or the control system are under at least one of the group of elevated structures.

12. A shade system that provides a predicted amount of shade and sunshine to an area covered by the shade system, comprising:
a plurality of elevated rectilinear shade structures, wherein each shade structure of the plurality of elevated rectilinear shade structures is a “solar table”, including a first solar table, wherein each shade structure has a long side and a short side, wherein the shade structures are grouped together but do not touch, oriented and aligned such that each shade structure of the plurality of elevated rectilinear shade structures has long sides generally oriented north to south and each shade structure of the plurality of elevated rectilinear shade structures has short sides generally oriented east to west.

13. The system of claim 12, wherein the shade structures are defined by a height of a shade canopy, a width of the shade canopy and a separation east to west of adjacent structures.

14. The system of claim 12, wherein the shade structure includes one or more solar panels for at least part of a length of the shade structure.

15. The system of claim 12, wherein the long sides of the shade structure are oriented within ±30° of the directly north to south orientation.

16. The system of claim 12, wherein a solar canopy is of sufficient height above the area to allow the area below to be used for something other than collection of solar energy.

17. The system of claim 12, wherein the solar table covers batteries, a greenhouse, storage tanks, or electronics gear.

18. The system of claim 12, wherein (a) one or more types of plants are grown under the system, or (b) one or more types of animals are raised under the system.

19. The system of claim 12, wherein at least one of the plurality of elevated rectilinear shade structures supports at least one of water pipes, grow lights, work lighting, security lighting, fixed fencing, movable fencing, a sign, a portion of a shelter, a greenhouse, non-solar renewable energy generators, or electrical equipment related to an operation of a plurality of solar energy panels.

20. The system of claim 12, wherein a second solar table comprises only one column and only one crossbeam and is connectable to the first solar table by connecting at least one purlin of the second solar table to at least one purlin of the first solar table.
